(19) United States
(12) Patent Application Publication
(10) Pub. No.: US 2008/0228991 A1
(43) Pub. Date: Sep. 18, 2008

(54) RING BUFFER MANAGEMENT

(75) Inventors: Sebastien FERROUSSAT, Douvres (FR); Patrice COUVERT, Saint-Marcellin (FR); Xavier CAUCHY, Laval (FR); Anthony PHILIPPE, Grenoble (FR)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: STMICROELECTRONICS SA, MONTROUGE (FR)

(21) Appl. No.: 12/046,623

(22) Filed: Mar. 12, 2008

(30) Foreign Application Priority Data
Mar. 13, 2007 (FR) 07 01801

(51) Int. Cl. G06F 12/00

(52) U.S. Cl. 711/100; 711/E12.001

(57) ABSTRACT

A method is provided for managing access to a ring buffer, for at least one data transfer channel for a determined amount of data, with this ring buffer comprising a series of buffer sub-areas spaced apart by a memory address offset and ordered from a first buffer sub-area to a last buffer sub-area. A starting address is initialized from a first register storing the value of the memory address of the first buffer sub-area, and a counter is initialized from a second register storing the value of the number of buffer sub-areas in the buffer. The buffer sub-areas are successively accessed, from the first buffer sub-area to the last buffer sub-area, starting from the starting address and as a function of the memory address offset, on the basis of the value of the counter. The initialization and access steps are repeated such that the determined amount of data is transferred.

### CROSS-REFERENCE TO RELATED APPLICATIONS

This application is based upon and claims priority from French Patent Application No. 07 01801, filed Mar. 13, 2007, the entire disclosure of which is herein incorporated by reference.

### FIELD OF THE INVENTION

The present invention relates to data processing systems, and more particularly to the management of access to a ring buffer.

### BACKGROUND OF THE INVENTION

In certain applications, for example in the domain of video, a mass storage device, or external memory, stores data to be processed according to a given algorithm by a processor of a data processing device.

The internal memory of a microprocessor is generally of relatively reduced capacity in comparison to an external memory where data, representing video images for example, can be stored. The transfer of data from external memory to internal memory allows the microprocessor to partially process, in other words process in steps, all of the data of a video image.

To realize such a data transfer from external memory to internal memory, it is conventional to use a DMA (Direct Memory Access) device. Such a DMA device enables direct data transfers between the external memory and the internal memory that is associated with the processor without requiring the intervention of the microprocessor, with some exceptions, such as when initiating and concluding a data transfer.

The use of a ring buffer for this purpose is very advantageous. A ring buffer has buffer sub-areas which are used in a circular manner. Various access management methods can be implemented for accessing such a ring buffer.

These access management methods can correspond to a “link function” in which control registers for each data transfer channel of the DMA device contain an address used to manage the memory access. At this address is stored a set of parameters for each programmed data transfer, which are used to manage the ring buffer access.

Such parameters can be more or less complex to manage, depending on the number of dimensions corresponding to the data transfer. Thus, one can have a one-dimensional transfer, which accesses one buffer sub-area of the ring buffer, or a two-dimensional transfer, in which all the buffer sub-areas of the ring buffer are accessed. One can also perform another pass of the same type through the ring buffer, visiting the buffer sub-areas of the ring buffer multiple times, either wholly or in part.

More specifically, in the control registers for each data transfer channel of the DMA device is stored the memory address intended to be used, at the end of a programmed pass through buffer sub-areas, to retrieve the next set of parameters. The next set of parameters corresponds to the next pass through buffer sub-areas to be followed from the external memory to the internal memory, or vice versa.

Such a ring buffer access management method has numerous disadvantages.

For example, it requires a specific mechanism for retrieving the set of parameters for each new pass through the buffer sub-areas.

In addition, this retrieval of the set of parameters can introduce a delay in the management of DMA data transfers, particularly when the sets of parameters are stored outside the DMA device.

When these sets of parameters are only accessible by the DMA device via a DMA port which is used for other applications as well, additional problems may arise related to the bandwidth attached to this port. While the addition of a supplemental port could resolve such a bandwidth problem, this would introduce other problems, particularly an increase in the size of the DMA device which would result in an increase in the cost of the final device.

Such memory access management methods can also correspond to a two-dimensional data transfer based on the management of two offset values, a first offset which provides a path through a buffer sub-area of the ring buffer and a second offset which advances from the current buffer sub-area to the next buffer sub-area in the ring buffer. With such a system, a modulo function is used for advancing from the last buffer sub-area to the first buffer sub-area in the ring buffer.

However, as a modulo function places no restriction on the size of the modulo area and on the alignment of the start and end addresses of the modulo area, it requires a significant amount of logic. Duplicating this logic for each channel of a DMA device therefore presents a high cost relative to the size of the device. Most DMAs therefore do not have a modulo function for each channel. The modulo function can be realized at a lower cost in terms of the amount of logic, but then there are restrictions regarding the alignment of the start and end addresses of the modulo area, and also restrictions on the size of the area (often 2ⁿ elements).

### SUMMARY OF THE INVENTION

The present invention aims to overcome the above-mention disadvantages and to provide access management processes and devices that provide improved access to a ring buffer.

A first embodiment of the present invention provides a process for managing access to a ring buffer, for at least one data transfer channel for a determined amount of data, with the ring buffer comprising a series of buffer sub-areas spaced apart by a memory address offset and ordered from a first buffer sub-area to a last buffer-sub-area. A starting address is initialized from a first register that stores a value indicating a memory address of the first buffer sub-area of the ring buffer, and a counter is initialized from a second register that stores a value indicating the number of buffer sub-areas in the buffer. The buffer sub-areas are accessed successively from the first buffer sub-area to the last buffer sub-area, starting from the starting address and as a function of the memory address offset, on the basis of the value of the counter. These steps are repeated such that the determined amount of data is transferred.

A second embodiment of the present invention provides a management device for managing access to a ring buffer for a data transfer channel, with the device being adapted to implement such an access management process.

A third embodiment of the present invention provides a DMA device comprising such a management device.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 illustrates management of a ring buffer in accordance with an embodiment of the present invention,

FIG. 2 illustrates a buffer managed according to an embodiment of the present invention,

FIG. 3 illustrates the architecture of a device that manages a ring buffer according to an embodiment of the present invention,

FIG. 4 illustrates the management of a ring buffer in the context of a video data transfer according to an embodiment of the present invention, and

FIGS. 5 and 6 illustrate management of the data transfer between internal and external memories based on ring buffers.

### DETAILED DESCRIPTION OF THE PREFERRED EMBODIMENTS

Preferred embodiments of the present invention will be described in detail hereinbelow with reference to the attached drawings.

One embodiment of the present invention provides a process for managing access to a ring buffer, for at least one data transfer channel for a determined amount of data, with the ring buffer comprising a series of buffer sub-areas that are spaced apart by a memory address offset and ordered from a first buffer sub-area to a last buffer-sub-area. A starting address is initialized from a first register that stores a value indicating a memory address of the first buffer sub-area of the ring buffer, and a counter is initialized from a second register that stores a value indicating the number of buffer sub-areas in the ring buffer. The buffer sub-areas are accessed successively from the first buffer sub-area to the last buffer sub-area, starting from the starting address and as a function of the address offset, on the basis of the value of the counter. These two steps are repeated such that the determined amount of data is transferred.

Through this process, a read or write access to a ring buffer can be simply managed while limiting the number of registers to be managed.

By proceeding in this manner, accessing a set of parameters dedicated to the data transfer is no longer required, unlike the management of a ring buffer based on a link function. This, therefore, eliminates the disadvantages attached to such a management method.

In this process, the amount of data determined for a transfer channel, information used to determine whether the current transfer has completed, can be managed by any mechanism known to a person skilled in the art. For example, this amount of data to be transferred can be determined by the number of buffer sub-areas to be visited.

The transfer (read or write) of the data concerning a buffer sub-area can be done at a time which is relative to that of the data concerning the next buffer sub-area. These time management mechanisms are well known to a person of ordinary skill in the art. For example, when the next buffer sub-area is to be transferred, a DMA register can be written to by the system which incorporates the DMA device. The register so activated indicates to the DMA device that it is to continue the data transfer for the previously defined amount of data.

Also, access management for such a ring buffer, in the context of embodiments having multiple data transfer channels, is simple to implement once the first and second registers as well as the counter are managed for each transfer channel. Thus, there are removed the alignment constraints imposed by management based on a modulo function as described above.

In such a context, when a number N of distinct transfer channels are used to manage one or more ring buffers, the first and second registers and the counter are advantageously duplicated N times and managed independently for each data transfer channel.

The present invention is not limited regarding the use of the ring buffer. It can advantageously be implemented in the context of memory coupled to a microprocessor, but this is only an exemplary application of the present invention.

In one embodiment of the present invention, the access management process additionally comprises the following steps, before the initializing step. The starting address is initialized to a value indicating the address of a determined buffer sub-area among the buffer sub-areas of the ring buffer, and the counter is initialized to a value indicating the number of buffer sub-areas between the determined buffer sub-area and the last buffer sub-area. The buffer sub-areas are accessed successively from the determined buffer sub-area to the last buffer sub-area, as a function of the address offset and on the basis of the value of the counter.

In some embodiments, the ring buffer is comprised in a global memory. in such an embodiment, the following steps can be implemented before the initializing step. The starting address is initialized to a value indicating an address of a specific area of the global memory which is different from the buffer sub-areas of the ring buffer, and the counter is initialized to a value corresponding to an amount of data to be transferred from the specific area. The specific area of the global memory is accessed on the basis of the value of the counter.

In this case, the start of a data transfer can begin with transferring data from a memory area which is outside the buffer sub-areas of the ring buffer.

After having transferred the number of buffer sub-areas corresponding to the value initialized in the counter, the transfer restarts at the beginning of the ring buffer.

In one embodiment of the present invention, the accessing step comprises advancing through a current buffer sub-area, advancing to the next buffer sub-area, decrementing the counter by one unit, and, if the value of the counter is not 0, repeating these steps, or else returning to the initializing step.

By proceeding in this manner, the counter indicates the number of buffer sub-areas which remain to be visited including the last buffer sub-area of the ring buffer. Then, when it is detected that the last buffer-sub-area has just been visited, the initialization step is repeated. The implementation of such steps remains simple.

In one embodiment of the present invention, advancing through a current buffer sub-area comprises the following steps. A sub-counter is initialized from a third register indicating the size of a buffer sub-area. The current buffer sub-area is accessed based on the size by decrementing the sub-counter. If the value of the sub-counter is not 0, return to access the current buffer sub-area, or else go to advance to the next buffer sub-area.

Thus, the access to a buffer sub-area of the buffer is managed on the basis of the management of a sub-counter and a register indicating the size of this buffer sub-area.

Another embodiment of the present invention provides a management device for managing access to a ring buffer for a data transfer channel, with the device being adapted to implement such an access management process.

A further embodiment of the present invention provides a DMA device comprising a management such device.

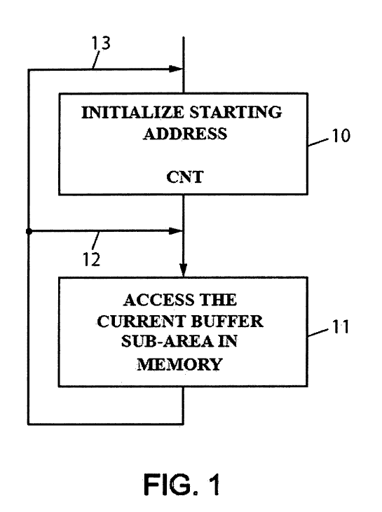

Exemplary embodiments of the present invention will now be described in detail with reference to FIGS. 1-6.

FIG. 1 illustrates the management of a ring buffer in accordance with an embodiment of the present invention. This embodiment is based on an initialization step 10 for initializing a starting point in the pass through the ring buffer in order to perform the data transfer. This starting point in memory corresponds to a starting address which is retrieved from a first register. During this initialization step 10, a buffer sub-area counter is also initialized from a second register which indicates the number of buffer sub-areas to be accessed in the ring buffer.

This initialization step is performed at the end of each pass through the ring buffer.

Once this step 10 is realized, the current buffer sub-area in the ring buffer is accessed in step 11.

In this manner, the buffer sub-areas are successively accessed one by one, from first to last.

This step 11 of accessing a current buffer sub-area is based on: the starting address for the access, the size of a buffer sub-area in memory, an address offset which is used to advance from a current buffer sub-area to a next buffer sub-area, and the management of a counter which indicates the number of buffer sub-areas which remain to be visited before reaching the last buffer sub-area.

Thus, after accessing the current buffer sub-area in the ring buffer, it is possible either: to advance to a next buffer sub-area (arrow 12), if the counter indicates that there remains at least one next buffer sub-area to be visited in the ring buffer; or, when the current buffer sub-area just visited corresponds to the last buffer sub-area in the ring buffer, to repeat the initialization step 10 (arrow 13) in order to restart a programmed pass through the ring memory.

The data transfer, whether read or write, is complete when a determined amount of data has been transferred. This aspect will not be described in detail. Any method known to a person of ordinary skill in the art can be used to check for the end of the transfer.

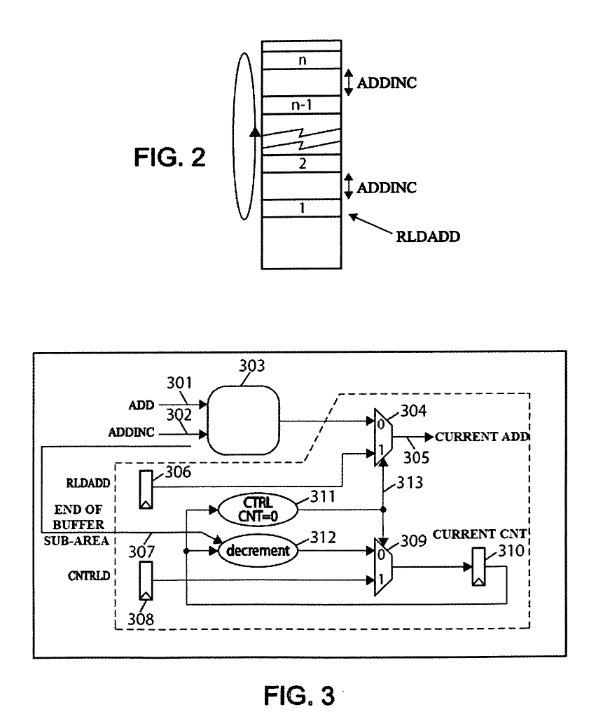

FIG. 2 illustrates a ring buffer managed according to an embodiment of the present invention. This ring buffer comprises a whole number n of successive buffer sub-areas. These buffer sub-areas are spaced apart from each other by an address offset ADDINC, and the address of the first element stored in the first buffer sub-area is labeled RLDADD.

The following labels are used in the description below:

ADD, for the current address, meaning the address of the data to be read from or written to the buffer;

ADDINC, the address offset between two successive buffer sub-areas, with this address offset being equal to one unit if the buffer sub-areas are next to each other;

NBELT, the number of elements remaining to be transferred for the current buffer sub-area;

NBELT_RLD, the total number of elements in each buffer sub-area;

RLDADD (for “ReLoaD ADDress”), the starting address for the pass through the ring buffer;

CNT, the counter used to count the number of buffer sub-areas remaining to be read or written before returning to the first buffer sub-area; and

CNTRLD (for “CouNter ReLoaD value”), the number of buffer sub-areas minus 1.

Note that it is easy to adapt an embodiment of the present invention to the case where the managed address offset ADDINC represents an offset between the starting address of a buffer sub-area and the starting address of the next buffer sub-area.

At the end of a data transfer from a buffer sub-area, meaning when NBELT is equal to 0, the value of the counter CNT is checked.

If the value of the counter is not 0, then the next buffer sub-area is accessed. The counter value CNT is then decremented and the value of the current address ADD is modified to point to the first element of the next buffer sub-area, using the information ADDINC.

If the value of the counter is equal to 0, then the first buffer sub-area is accessed. The counter CNT is then reset to the value CNTRLD and the current address ADD is reset to the value RLDADD.

In one embodiment of the present invention, no matter what the value of the counter CNT, the field NBELT is reset to the value NBELT_RLD at each change of buffer sub-area.

Embodiments of the present invention advantageously provide simpler management of the ring buffer compared to management based on a link function or on a modulo function.

In one embodiment of the present invention, all of the n buffer sub-areas are accessed starting from a starting address RLDADD, which corresponds in the example to the address of the first data in the first buffer sub-area.

Then a pass is made through the different buffer sub-areas by incrementing the current address ADD of the end of a buffer sub-area with the address offset ADDINC, which allows advancing from one buffer sub-area to another and finishing a pass through the ring buffer with the buffer sub-area n.

A hardware configuration of a ring buffer access management device in accordance with an embodiment of the present invention can be based on the addition of a counter CNT and a decrementer for managing the counter, and two registers.

A ring buffer access management device adapted to implement such an access management process comprises, in one embodiment of the present invention a first register 306 adapted to contain a value indicating a memory address of the first buffer sub-area of the buffer, a second register 308 adapted to contain a value indicating the number of buffer sub-areas of the buffer, an initialization unit 304 and 309 adapted to initialize a starting address from the first register and to initialize a counter CNT from the second register, a ring buffer access management unit 303, and a repeated access management unit for managing repeated access to the ring buffer.

The ring buffer access management unit 303 is adapted to determine the successive memory addresses for successively accessing the buffer sub-areas from the first buffer sub-area to the last buffer sub-area, starting from the starting address and as a function of the address offset, on the basis of the value of the counter CNT. The repeated access management unit is adapted to trigger the ring buffer access management unit as a function of the determined amount of data.

The access management unit 303 can additionally be adapted to access a current buffer sub-area and advance to the next buffer sub-area; and can be adapted to cooperate with, in order to provide the current address (ADD) for the pass through the ring buffer, a decrementer 312 adapted to decrement the counter CNT by one unit at each advance to the next buffer sub-area, and a counter control unit 311 adapted to activate the first and second initialization units 304 and 309 if the value of the counter is equal to 0.

FIG. 3 illustrates such an architecture for a device implementing ring buffer memory management according to an embodiment of the present invention. This device comprises the address determination unit 303, which is adapted to determine the address of the next data to be read from or written to memory, starting from the current address ADD 301 of the last data read or written and based on an address offset ADDINC 302.

As long as the pass through the data contained in the buffer sub-areas of the ring buffer is unfinished, either the current buffer sub-area is accessed and the next address ADD is determined for the memory access by incrementing the previous address, or a complete pass has just been made through the buffer sub-area and the next current address is then determined in a manner which yields the first address of the next buffer sub-area to be accessed as a function of the address offset ADDINC.

When the data of the last buffer sub-area, meaning buffer sub-area n in the buffer, has been transferred, then the next address to be used for retrieving the next data corresponds to the one stored in the register RLDADD 306.

This device also comprises the counter control unit 311, which is responsible for checking whether the value of the counter CNT is equal to 0; and the decrementer 312, which is responsible for decrementing the value of the counter CNT as a function of the pass through the buffer sub-area. The decrementer 312 receives information about the end of the buffer sub-area 307, as well as the current value of the counter CNT 310. From this information, the decrementer is able to determine the new value of the counter CNT, representing the number of buffer sub-areas remaining to be visited before returning to the first buffer sub-area in the ring buffer.

When the control unit 311 detects that the value of the counter CNT is zero, it provides information indicating the end of the pass 313 to the address update unit 304 and the counter update unit 309. In this case, the address stored in the register RLDADD 306 is used for the next address in the buffer.

The update unit 304 is adapted to provide the next address of the data to be read or written, which, upon receipt of the information indicating the end of the pass 313, corresponds to the address contained in the register RLDADD, meaning the starting address of the first buffer sub-area in the ring buffer, and in other cases it provides the address determined by the determination unit 303.

The counter update unit 309 is adapted to provide the current value of the counter CNT 310, which corresponds either to the value of the counter CNT issued by the decrementer 312, or to the value stored in the register CNTRLD 308, with the latter value being provided upon receipt of the information indicating the end of the pass 313.

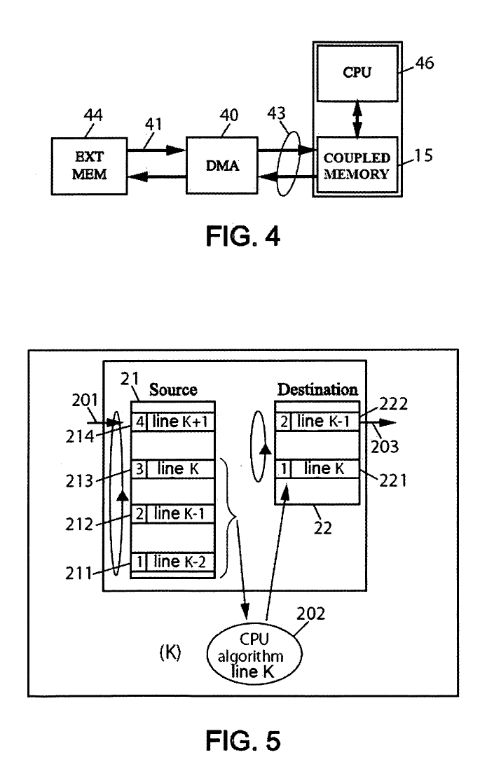

FIG. 4 illustrates ring buffer management for a transfer of video data according to an embodiment of the present invention.

This figure illustrates steps executed during the processing of video data in a DMA device 40. In an external memory 44 is stored data that is decoded from data encoded using a protocol such as MPEG-2 or MPEG-4 (where MPEG stands for “Moving Pictures Experts Group”). Some of the data stored in the external memory 44 is transferred to the internal memory 15 that is coupled to a microprocessor 46 via a message 41. Then, in an exchange of messages 43 between the microprocessor 46 and its internal memory 15 which is used as a ring buffer, the microprocessor retrieves this data from the internal memory 15 in order to process the data, and returns the processed data to the internal memory 15.

Then the processed data is sent by the DMA device to the external memory 44 for storage. In one application of video data processing, the processed data stored in this manner in the external memory is then used by display applications in order to display the images corresponding to this data.

By proceeding in this manner, the microprocessor can process image data in successive portions. To do this, an image is divided into multiple sub-blocks of data, which correspond to the successive portions to be processed as described above. The memory 15 is managed as one or more ring buffers for storing the data.

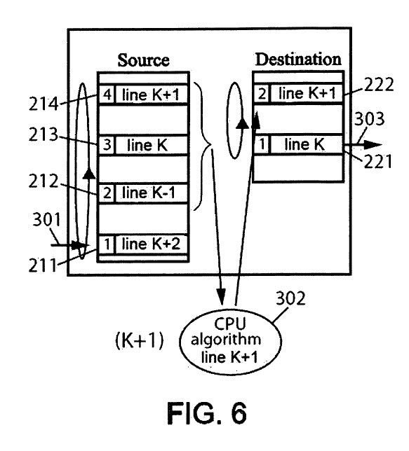

FIGS. 5 and 6 illustrate management of the data transfer between the internal and external memories based on ring buffers.

An image is represented as multiple horizontal lines Lⱼ of pixels P_{i, j}, where i is between 1 and N and j is between 1 and M, and M and N are whole numbers.

In the exemplary application described below with reference to FIGS. 5 and 6, the processing by the microprocessor of a pixel P_{i, j} in line Lⱼ of the image is based on the pixels P_{i, j} P_{i, j-1} and P_{i, j-2.} The internal memory comprises a source ring buffer 21 and a destination ring buffer 22. Such processing can therefore be implemented by processing the pixels of an image, line by line.

The source ring buffer 21 of this embodiment comprises four source buffer sub-areas 211-214, and the destination ring buffer 22 comprises two destination sub-areas 221 and 222.

As illustrated in FIG. 5, in a given step of the processing step K, the line of pixels L_{K-2} is stored in the source sub-memory 211, the line of pixels L_{K-1} is stored in the source sub-memory 212, and the line of pixels L_{K} is stored in the source sub-memory 213.

In this step K, the DMA device transfers the line of pixels L_{K+1} from the external memory to the source sub-memory 214 of the internal memory, in a sub-step 201.

Also in this step K, the microprocessor processes, in a sub-step 202, each of the pixels P_{i, K} in the line L_{K}, where i is between 1 and N, as a function of P_{i, K} and of the respective pixels P_{i, K-1} of the line L_{K-1} and P_{i, K-2} of the line L_{K-2} which are stored in the source sub-memory 211-213, as this is required by the processing to be applied to the image data stored in the external memory.

The new line L_{K} obtained at the end of the sub-step 202 implemented by the microprocessor is stored in the first destination sub-memory 221 of the internal memory.

Also, in a sub-step 203, the DMA device transfers the result obtained in the previous step K−1, meaning the line of pixels L_{K-1} processed by the microprocessor, from the second destination sub-memory 222 of the internal memory to the external memory.

In the next step, step K+1, as illustrated in FIG. 6, the line of pixels L_{K-1} is stored in the source sub-memory 212, the line of pixels L_{K} is stored in the source sub-memory 213, and the line of pixels L_{K+1} is stored in the source sub-memory 214.

In this step K+1, the DMA device transfers the line of pixels L_{K+2} from the external memory to the source sub-memory of the internal memory, in a sub-step 301.

Also in this step K+1, the microprocessor processes, in a sub-step 302, each of the pixels P_{i, K+1} of the line L_{K+1,} where i is between 1 and N, as a function Of P_{i, K+1} and of the respective pixels P_{i, K} of the line L_{K} and P_{i, K-1} of the line L_{K-1} which are stored in the source sub-memories 212-214 of the internal memory.

The new line L_{K+1} obtained at the end of the sub-step 302 implemented by the microprocessor is then stored in the second destination sub-memory 222 of the internal memory.

Also, in a sub-step 303, the DMA device transfers the result obtained in the previous step K, meaning the line of pixels L_{K} processed by the microprocessor, from the first destination sub-memory 221 of the internal memory to the external memory.

The steps described above can be repeated to allow the microprocessor to process all of the data of the image stored in the external memory, particularly for display purposes, by applying an access management process according to an embodiment of the present invention.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. An access management method for managing access to a ring buffer, for at least one data transfer channel for a determined amount of data, the ring buffer comprising a series of buffer sub-areas spaced apart by a memory address offset and ordered from a first buffer sub-area to a last buffer sub-area, the process comprising the steps of:
initializing a starting address from a first register that stores a value indicating a memory address of the first buffer sub-area of the ring buffer, and initializing a counter from a second register that stores a value indicating the number of buffer sub-areas of the ring buffer;
accessing the buffer sub-areas successively from the first buffer sub-area to the last buffer sub-area, starting from the starting address and as a function of the memory address offset, on the basis of the value of the counter; and
repeating the initializing and accessing steps so as to transfer the determined amount of data.

2. The access management method according to claim 1, further comprising, before the initializing step, the steps of:
initializing the starting address with a value indicating an address of a determined buffer sub-area from among the buffer sub-areas of the ring buffer, and initializing the counter with a value indicating the number of buffer sub-areas comprised between the determined buffer sub-area and the last buffer sub-area; and
accessing the buffer sub-areas in succession from the determined buffer sub-area up to the last buffer sub-area, as a function of the memory address offset and on the basis of the value of the counter.

3. The access management method according to claim 1,
wherein the ring buffer is comprised in a global memory, and
the method further comprises, before the initializing step, the steps of:
initializing the starting address to a value indicating an address of a specific area in the global memory that is different from the buffer sub-areas of the ring buffer, and initializing the counter to a value corresponding to an amount of data to be transferred from the specific area; and
accessing the specific area in the global memory on the basis of the value of the counter.

4. The access management method according to claim 1,
wherein the ring buffer is adapted to be used for a number N of distinct data transfer channels, and
the first and second registers and the counter are duplicated N times and managed independently for each of the data transfer channels.

5. The access management method according to claim 1, wherein the accessing step comprises:
accessing a current buffer sub-area;
advancing to the next buffer sub-area;
decrementing the counter by one unit; and
if the value of the counter is not 0, repeating the accessing, advancing, and decrementing,

6. The access management method according to claim 5, wherein the accessing step further comprises:
if the value of the counter is 0, returning to the initializing step.

7. An access management device for managing access to a ring buffer for a data transfer channel for a determined amount of data, the ring buffer comprising a series of buffer sub-areas spaced apart by an address offset and ordered from a first buffer sub-area to a last buffer sub-area, with the device comprising:
a first register adapted to contain a value indicating a memory address of the first buffer sub-area of the ring buffer;
a second register adapted to contain a value indicating the number of buffer sub-areas of the ring buffer;
a first initialization unit adapted to initialize a starting address from the first register;
a second initialization unit adapted to initialize a counter from the second register;
a ring buffer access management unit adapted to determine the successive memory addresses which allow successively accessing the buffer sub-areas from the first buffer sub-area to the last buffer sub-area, starting from the starting address and as a function of the address offset, on the basis of the value of the counter; and
a repeated access management unit for managing repeated accesses to the ring buffer, the repeated access management unit being adapted to trigger the ring buffer access management unit as a function of the determined amount of data.

8. The access management device according to claim 7,
wherein the ring buffer is adapted to be used for a number N of distinct data transfer channels, and
the first and second registers and the counter are duplicated N times and managed independently for each of the data transfer channels.

9. The access management device according to claim 7, wherein the ring buffer access management unit is also adapted to:
advance through a current buffer sub-area,
advance to the next buffer sub-area, and
in order to provide the current address of the pass through the ring buffer, cooperate with a decrementer adapted to decrement the counter by one unit for each advance to the next buffer sub-area, and a counter control unit adapted to activate the first and second initialization units if the value of the counter is equal to 0.

10. A DMA device comprising the access management device according to claim 7.

11. A tangible computer-readable medium encoded with a computer program for managing access to a ring buffer, for at least one data transfer channel for a determined amount of data, the ring buffer comprising a series of buffer sub-areas spaced apart by a memory address offset and ordered from a first buffer sub-area to a last buffer sub-area, the computer program containing instructions for performing the steps of:
initializing a starting address from a first register that stores a value indicating a memory address of the first buffer sub-area of the ring buffer, and initializing a counter from a second register that stores a value indicating the number of buffer sub-areas of the ring buffer;
accessing the buffer sub-areas successively from the first buffer sub-area to the last buffer sub-area, starting from the starting address and as a function of the memory address offset, on the basis of the value of the counter; and
repeating the initializing and accessing steps so as to transfer the determined amount of data.

12. The tangible computer-readable medium according to claim 11, wherein the computer program further contains instructions for performing, before the initializing step, the steps of:
initializing the starting address with a value indicating an address of a determined buffer sub-area from among the buffer sub-areas of the ring buffer, and initializing the counter with a value indicating the number of buffer sub-areas comprised between the determined buffer sub-area and the last buffer sub-area; and
accessing the buffer sub-areas in succession from the determined buffer sub-area up to the last buffer sub-area, as a function of the memory address offset and on the basis of the value of the counter.

13. The tangible computer-readable medium according to claim 11,
wherein the ring buffer is comprised in a global memory, and
the computer program further contains instructions for performing, before the initializing step, the steps of:
initializing the starting address to a value indicating an address of a specific area in the global memory that is different from the buffer sub-areas of the ring buffer, and initializing the counter to a value corresponding to an amount of data to be transferred from the specific area; and
accessing the specific area in the global memory on the basis of the value of the counter.

14. The tangible computer-readable medium according to claim 11,
wherein the ring buffer is adapted to be used for a number N of distinct data transfer channels, and
the first and second registers and the counter are duplicated N times and managed independently for each of the data transfer channels.

15. The tangible computer-readable medium according to claim 11, wherein the accessing step comprises:
accessing a current buffer sub-area;
advancing to the next buffer sub-area;
decrementing the counter by one unit; and
if the value of the counter is not 0, repeating the accessing, advancing, and decrementing,

16. The tangible computer-readable medium according to claim 15, wherein the accessing step further comprises:
if the value of the counter is 0, returning to the initializing step.
